(19) United States
(12) Patent Application Publication
(10) Pub. No.: US 2006/0056049 A1
(43) Pub. Date: Mar. 16, 2006

(54) Lens-interchangeable camera combining image pickup device and interchangeable lens unit combining image pickup device

(75) Inventors: Kentaro Tokiwa, Asaka-shi (JP); Takehiko Senba, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/226,281

(22) Filed: Sep. 15, 2005

(30) Foreign Application Priority Data
Sep. 15, 2004 (JP) 2004-268810

(51) Int. Cl. G02B 15/14

(52) U.S. Cl. 359/684

(57) ABSTRACT

The present invention provides a lens-interchangeable camera combining an image pickup device, comprising: a lens unit having a lens and the image pickup device; a camera body having a lens unit connection portion to which the lens unit can be detachably attached; and a heat conducting elastic member which elastically abuts the lens unit and the camera body when the lens unit is attached to the camera body through the lens unit connection portion, and which conducts heat generated by the lens unit to the camera body. In this way, heat is conducted from the lens unit to the camera body without any hindrance to the attachment operation when the lens unit is used by being attached to the camera body, thus easily dissipating heat.

### BACKGROUND OF THE INVENTION

1. Field of the Invention

The present invention relates to a lens-interchangeable camera and, more particularly, to a lens-interchangeable camera incorporating an image pickup device in an interchangeable lens unit.

2. Related Art

In recent years, lens-interchangeable cameras capable of interchanging lens units each combining a picture taking lens and an image pickup device have been proposed. In such lens-interchangeable cameras, the image pickup device, a circuit board and other components generate heat when the lens unit is powered and driven after being attached to the camera. It is desirable to provide a heat dissipation mechanism capable of efficiently dissipate heat without any hindrance to the lens unit attachment/detachment operation in order to maintain the temperature in the camera within a predetermined range. Also, the amount of generated heat varies among various lens unit depending on the image pickup devices and the characteristics of a circuit board material, etc. Therefore, it is desirable to provide a heat dissipation mechanism according to the amount of heat generated by each lens unit.

Various heat dissipation mechanisms have been devised for dissipation of heat generated by solid image pickup devices. For example, Japanese Patent Application Laid-Open No. 8-139871 discloses an image reader in which a heat radiating plate maintained in close contact with a solid image pickup device is formed into such a shape as to surround a circuit board for driving the image pickup device. Also, Japanese Patent Application Laid-Open No. 9-37161 discloses a solid image pickup device cooling mechanism including a cooling device attached to an image pickup device. A heat conducting plate formed by bending a thin copper plate or the like is set in close contact with a surface of the heat conducting plate and is tightly screwed to a camera frame.

The techniques for the above-described heat dissipation mechanisms were provided without considering interchange of lenses. In the case of an application to a lens-interchangeable camera combining an image pickup device, therefore, the techniques for the above-described heat dissipation mechanisms have a drawback in that the camera body structure or the lens unit structure is complicated and increased in size, and another drawback in that complicated lens unit attachment and detachment operations are required. For example, since the lens unit is ordinarily made airtight, it is inefficient to use one of the above-described heat dissipation mechanisms for completion of dissipation of heat in the lens unit, and an increase in size of the camera system cannot be avoided.

### SUMMARY OF THE INVENTION

In view of the above-described circumstances, an object of the present invention is to provide, as a lens-interchangeable camera combining a image pickup device, a compact lens-interchangeable camera simple in structure and capable of efficiently and easily releasing heat generated in any of lens units to the outside of the lens unit without any hindrance to lens unit attachment and detachment operations when the lens unit is attached to the camera body and used by being driven, and to provide a lens unit combining the image pickup device and attached to the lens-interchangeable camera.

To achieve the above-described object, according to a first aspect of the present invention, there is provided a lens-interchangeable camera combining an image pickup device, the camera including a lens unit having a lens and the image pickup device, a camera body having a lens unit connection portion to which the lens unit can be detachably attached, and a heat conducting elastic member which elastically abuts the lens unit and the camera body when the lens unit is attached to the camera body through the lens unit connection portion, and which conducts heat generated by the lens unit to the camera body.

According to the first aspect, the heat conducting elastic member abuts the lens unit and the camera body when the lens unit is used by being attached to the camera body. In this state, the heat conducting elastic member conducts heat generated by the image pickup device in the lens unit from the lens unit to the camera body. In this way, heat is conducted from the lens unit to the camera body without any hindrance to the attachment operation when the lens unit is used by being attached to the camera body, thus easily dissipating heat.

To achieve the above-described object, according to a second aspect of the present invention, there is provided a lens-interchangeable camera combining an image pickup device, the lens unit of the camera in the first aspect having a circuit board on which the image pickup device is mounted in a state of abutting thereon, and the heat conducting elastic member has its one surface maintained in abutment on the circuit board directly or through a heat conducting portion and has its another surface maintained in abutment on the camera body.

According to the second aspect, the heat conducting elastic member has its one surface maintained in abutment on the circuit board directly or through the heat conducting portion and has its another surface maintained in abutment on the camera body when the lens unit is used by being attached to the camera body. Heat generated by the image pickup device, the circuit board and other components in the lens unit is thereby conducted to the camera body. Thus, the heat conducting elastic member abuts the heat generation source and the portion through which heat is to be dissipated, thereby enabling heat to be efficiently conducted from the lens unit to the camera body to be dissipated.

To achieve the above-described object, according to a third aspect of the present invention, there is provided a lens-interchangeable camera combining an image pickup device, the lens unit of the camera in the first aspect having a circuit board connected to the image pickup device, and the heat conducting elastic member having its one surface maintained in abutment on the image pickup device directly or through a heat conducting portion and having its another surface maintained in abutment on the camera body.

According to the third aspect, the heat conducting elastic member has its one surface maintained in abutment on the image pickup device directly or through the heat conducting portion and has its another surface maintained in abutment on the camera body when the lens unit is used by being attached to the camera body. Heat generated by the image pickup device and other components in the lens unit is thereby conducted from the lens unit to the camera body. Thus, the heat conducting elastic member abuts the heat generation source and the portion through which heat is to be dissipated to enable heat to be efficiently conducted from the lens unit to the camera body to be dissipated, even in a case where the image pickup device, connected to the circuit board, is not mounted on the circuit board.

To achieve the above-described object, according to a fourth aspect of the present invention, there is provided a lens-interchangeable camera combining an image pickup device, wherein the heat conducting elastic member of the camera in the first, second or third aspect is provided in a mount abutment portion at which the lens unit and a surface of the camera body abut each other when the lens unit is attached to the lens unit connection portion.

According to the fourth aspect, the heat conducting elastic member constitutes the lens unit and the mount abutment portion of the camera to conduct heat generated in the lens unit to the camera body. In this way, the length of the path through which heat is conducted in the lens optical axis direction from the lens unit to the camera body is reduced to achieve a reduction in the thickness of the camera in the optical axis direction and, hence, a reduction in overall thickness of the camera.

To achieve the above-described object, according to a fifth aspect of the present invention, there is provided a lens-interchangeable camera combining an image pickup device, wherein the heat conducting elastic member of the camera in the first, second, third, or fourth aspect is provided on the lens unit.

According to the fifth aspect, the heat conducting elastic member is provided integrally with the lens unit, thereby reducing the number of component parts and improving the facility with which the lens unit is attached to the camera body. Also, a heat conducting elastic member suitable for a characteristic of the image pickup device, the circuit board or any other component incorporated in the main unit can be provided to ensure efficient heat conduction from the lens unit to the camera body.

To achieve the above-described object, according to a sixth aspect of the present invention, there is provided a lens-interchangeable camera combining an image pickup device, wherein the heat conducting elastic member of the camera in the first, second, third or fourth aspect is provided in the camera body.

According to the sixth aspect, the heat conducting elastic member is provided integrally with the camera body, thereby reducing the number of component parts of the camera and improving the facility with which the lens unit is attached to the camera body. Also, a heat conducting elastic member suitable for the shape of the camera body, the heat conducting portion provided in the camera body or the lens unit connection portion provided in the camera body, or for a characteristic of a material, can be provided to ensure efficient heat conduction from the lens unit to the camera body.

To achieve the above-described object, according to a seventh aspect of the present invention, there is provided a lens-interchangeable camera combining an image pickup device, wherein the heat conducting elastic member of the camera in the first, second, third or fourth aspect is formed so as to be detachably attached to at least one of the lens unit and the camera body.

According to the seventh aspect, the heat conducting elastic member is provided integrally with at least one of the lens unit and the camera body so as to be detachably attached to the same, thereby reducing the number of component parts of the camera, improving the facility with which the lens unit is attached to the camera body, and enabling selection of a suitable one of various heat conducting elastic members or interchange between the heat conducting elastic members.

To achieve the above-described object, according to an eighth aspect of the present invention, there is provided a lens-interchangeable camera combining an image pickup device, wherein the camera according to any one of the first to seventh aspects further includes at least one of a heat sink and a cooling fan provided in the camera body to maintain the temperature in the camera within a predetermined range.

According to the eighth aspect, the heat sink or the cooling fan performs cooling or circulating dissipation of heat from the heat conducting heat radiating member of the camera body to maintain the temperature in the camera in the predetermined range with higher efficiency.

To achieve the above-described object, according to a ninth aspect of the present invention, there is provided an interchangeable lens unit combining an image pickup device and capable of being detachably attached to a camera body, the lens unit including a lens, the image pickup device, a circuit board on which the image pickup device is mounted, and a heat conducting elastic member which elastically abuts the circuit board directly or through a heat conducting portion for conducting generated heat, wherein the heat conducting elastic member can elastically abut the camera body when the lens unit is attached to the camera body.

According to the ninth aspect, the lens unit elastically abuts the camera body with the heat conducting elastic member interposed therebetween. The heat conducting elastic member is thereby brought into abutment on the heat generation source and the portion through which heat is to be dissipated to achieve efficient heat conduction from the lens unit to the camera body.

To achieve the above-described object, according to a tenth aspect of the present invention, there is provided an interchangeable lens unit combining an image pickup device and capable of being detachably attached to a camera body, the lens unit including a lens, the image pickup device, a circuit board connected to the image pickup device, and a heat conducting elastic member which elastically abuts the image pickup device directly or through a heat conducting portion for conducting generated heat, wherein the heat conducting elastic member can elastically abut the camera body when the lens unit is attached to the camera body.

According to the tenth aspect, the heat conducting elastic member abuts the heat generation source and the portion through which heat is to be dissipated to enable heat to be efficiently conducted from the lens unit to the camera body to be dissipated, even in a case where the image pickup device, connected to the circuit board, is not mounted on the circuit board.

To achieve the above-described object, according to an eleventh aspect of the present invention, the camera body of the camera in any one of the first to eighth aspects has in its front surface a lens unit connection portion to which the lens unit can be detachably connected, and has a display monitor in its rear surface.

According to the eleventh aspect, heat generated from the lens unit and heat generated by the display monitor provided in the rear surface of the camera body can be conducted to the heat conducting elastic member, thereby further reducing the malfunction rate of the camera.

In each aspect of the present invention, the surface that the heat conducting elastic member abuts may be either of a surface for close contact and a surface such as a meshlike surface formed of discrete points.

According to the present invention, the heat conducting elastic member abuts the lens unit and the camera body to conduct generated by the image pickup device, the circuit board and other components in the lens unit from the lens unit to the camera body, thus achieving efficient heat conduction in a simple way without any hindrance to lens mounting.

Also, the present invention is effective particularly in heat dissipation from a lens unit which is made airtight or watertight according to a dustproof or waterproof specification, and in which a high-temperature condition occurs easily due to the airtight or watertight condition.

### BRIEF DESCRIPTION OF THE DRAWINGS

FIG. 1 is a diagram showing an appearance of a lens-interchangeable camera combining an image pickup device and an interchangeable lens unit combining an image pickup device in a preferred embodiment of the present invention;

FIG. 2 is a block diagram of the lens-interchangeable camera combining an image pickup device;

FIG. 3 is a sectional view of an essential portion of a first embodiment of the lens-interchangeable camera combining an image pickup device;

FIG. 4 is a sectional view of an essential portion of a second embodiment of the lens-interchangeable camera combining an image pickup device; and

FIG. 5 is a sectional view of an essential portion of a third embodiment of the lens-interchangeable camera combining an image pickup device.

### DETAILED DESCRIPTION OF THE PREFERRED EMBODIMENTS

Preferred embodiments of a lens-interchangeable camera combining an image pickup device and an interchangeable lens unit combining an image pickup device in accordance with the present invention will be described with reference to the accompanying drawings.

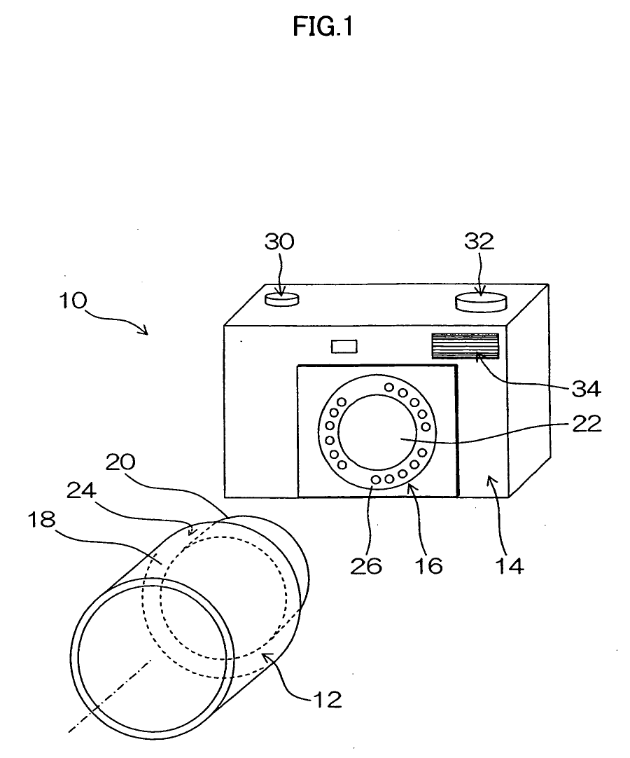

FIG. 1 is a perspective view of an appearance of an embodiment of a lens-interchangeable camera 10 combining an image pickup device in accordance with the present invention.

As shown in FIG. 1, the camera 10 is constituted by an interchangeable lens unit 12 (hereinafter referred to as lens unit 12) combining an image pickup device, and a camera body 14. The lens unit 12 is detachably attached to the camera body 14 and integrally combined with the camera body 14 by being mounted on a lens unit connection portion 16 provided in a front face of the camera body 14. The lens unit 12 is constituted by a lens barrel portion 18 in which a picture taking lens and other elements are disposed, and which is formed into the shape of a cylinder projecting from the surface of the camera body 14, and a camera body fitting portion 20 formed into the shape of a cylinder capable of being fitted in the camera body 14 and having an outer circumference smaller than that of the lens barrel portion 18. When the lens unit 12 is attached to the camera body 14, a mount abutment portion 24 formed between the lens barrel portion 18 and the camera body fitting portion 20 abuts the surface of the camera body 14. The lens unit connection portion 16 is constituted by a lens unit fitting portion 22 which is recessed from the surface of the camera body 14, and to which the lens unit 12 is fitted, and a mount abutment portion 26 which is formed in the surface of the camera body 14, and which abuts the lens unit 12. In FIG. 1, reference numerals 30 in FIG. 1 denote a release switch, reference numerals 32 a mode change switch, reference numerals 34 a strobe.

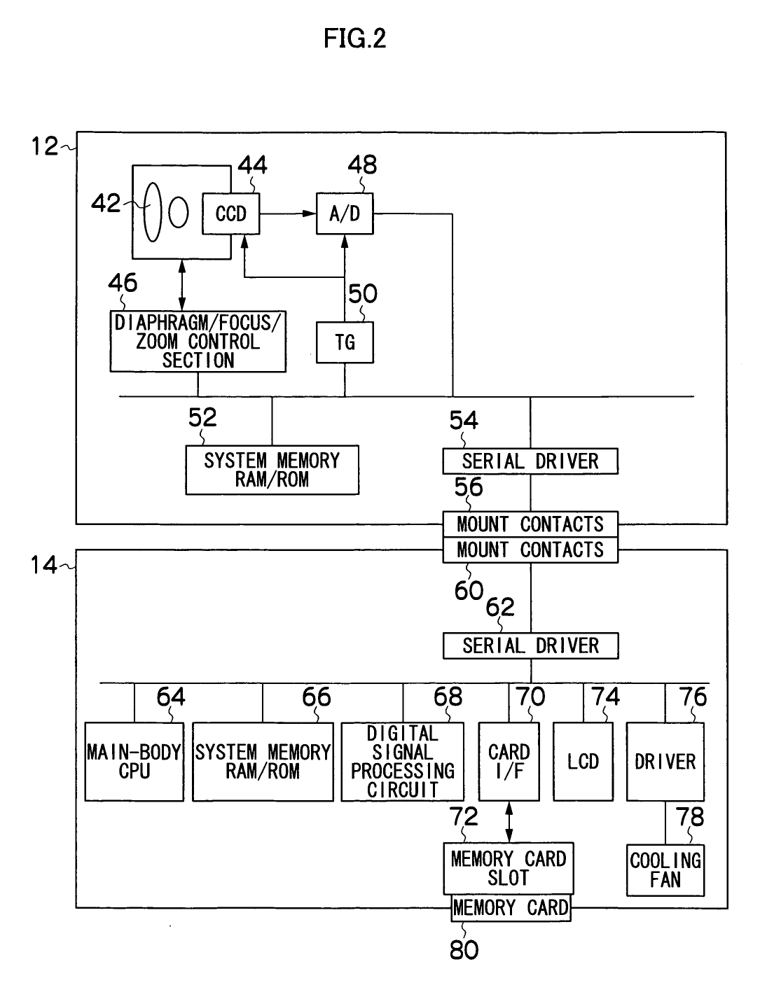

FIG. 2 is a block diagram showing the embodiment of the lens-interchangeable camera combining an image pickup device and the interchangeable lens unit combining an image pickup device in accordance with the present invention. As shown in FIG. 2, the lens unit 12 has as its main components a picture taking lens 42, a solid image pickup device (CCD) 44, a diaphragm/focusing/zoom control section 46, an analog processing circuit 48 including an A/D converter, a timing generator 50, a system memory (ROM/RAM) 52, a serial driver 54, and mount contacts 56. Main components of the camera in the camera body 14 are mount contacts 60, a serial driver 62, a central processing circuit (CPU) 64, a system memory (ROM/RAM) 66, a digital signal processing circuit 68, an interface (I/F) 70 for attachment of a memory card, a memory card slot 72, a liquid crystal display (LCD) 74, a cooling fan driver 76, and a cooling fan 78. On the camera body 14 are also provided other components (not shown) including a strobe control section, an LCD monitor, a power supply section, and operating components (various keys and switches such as a power switch, a release switch, an up/down key, left/right key, and an execution key).

In a state where the lens unit 12 is attached to the camera body 14 is through the mount contacts 56 and 60, the lens-interchangeable camera 10 combining the image pickup device operates as described below.

When the power switch (not shown) provided on the camera body 14 is turned on, the CPU 64 in the camera body 14 detects turning on of the switch, loads control programs from the system memory 52 in the lens unit 12 through the serial drivers 62 and 54, reads out from the system memory 52 various sorts of data necessary for adjustment of the lens unit 12, and stores the data in the system memory 66 in the camera body 14.

The control programs stored in the system memory 52 in the lens unit 12 comprise control programs representing methods of controlling the CCD 44 and the timing generator 50 for driving the CCD and a method of processing in the digital signal processing circuit 68, and a method of controlling the lens unit cooling fan. The various sorts of data necessary for adjustment of the lens unit 12 are sorts of data, such as adjustment values specific to the lens unit, necessary for control of the picture taking section and image signal processing section (more specifically, CCD characteristic data such as information on defects in the CCD 44, the number of pixels, a color filter array, color balance and sensitivity, and characteristics of the picture taking lens 42 (shading and distortions).

The CPU 64 performs centralized control on the circuits in the lens-interchangeable camera 10 combining the image pickup device on the basis of the control programs and data stored in the system memory 66. The CPU 64 controls the lens unit 12 and performs such control that suitable signal processing corresponding to the information specific to the lens unit 12 is performed in the digital signal processing circuit 68. The CPU 64 also performs control for picture taking in response to an input signal from the release switch (not shown) provided on the camera body 14 and control for read from the memory card 80 and write to the memory card 80.

That is, when the release switch is half pressed, the CPU 64 outputs a control signal to the diaphragm/focusing/zoom control section 46 through the serial drivers 62 and 54 and the mount contacts 60 and 56 to move the picture taking lens 42 to an in-focus position. When the release switch is fully pressed and when a predetermined exposure value is reached, the CPU 64 outputs a control signal to the diaphragm/focusing/zoom control section 46 to form an image of a subject on the light receiving surface of the CCD 44.

The subject image formed on the light receiving surface of the CCD 44 is photoelectrically converted into an image signal, which is sequentially read out. This image signal is supplied to the analog processing circuit 48 including a gain control (GC) circuit, a color balancing circuit and an A/D converter. After undergoing predetermined processing in the analog processing circuit 48, the image signal is converted into a digital signal. The digital signal is transferred to the digital signal processing circuit 68 in the camera body 14 through the serial drivers 54 and 62.

The digital signal processing circuit 68 includes a brightness signal generation circuit, a color difference signal generation circuit, a gamma correction circuit, a compression/decompression circuit and a memory controller. Image data processed by these circuits is recorded in the memory card 80 loaded in the memory card slot 72.

The image data stored in the memory card 80 can be read under the control of the CPU 64. The image data read out undergoes decompression processing in the digital signal processing circuit 68 and is output from the digital signal processing circuit 68 to the LCD 74.

As described above, the lens-interchangeable camera 10 combining the image pickup device becomes able to perform picture taking and transmission/reception of image and control signals when the lens unit 12 is attached to the lens unit connection portion 16 of the camera body 14 and electrically connected through the mount contacts 58 and 60.

When the lens-interchangeable camera 10 combining the image pickup device becomes able to perform picture taking, the CCD 44 in the lens unit 12 is supplied with electric power from the camera body 14 to generate heat through the mount contacts 56 and 60. When the temperatures of internal portions of the lens unit 12 become higher than a predetermined temperature, the lens-interchangeable camera 10 combining the image pickup device becomes unable to operate normally due to a cause such as a deterioration in electrical characteristics of the interchangeable lens unit 12 combining the image pickup device. For example, an increase in noise occurs due to an increase in dark current when the temperature of the CCD 44 is high.

Therefore, heat generated by the CCD 44 in the lens unit 12 is released by being efficiently conducted from the CCD 44 to the camera body 14 when the lens unit 12 and the camera body 14 are electrically connected. In this way, deterioration of electrical the characteristics of the components in the lens unit 12 is prevented.

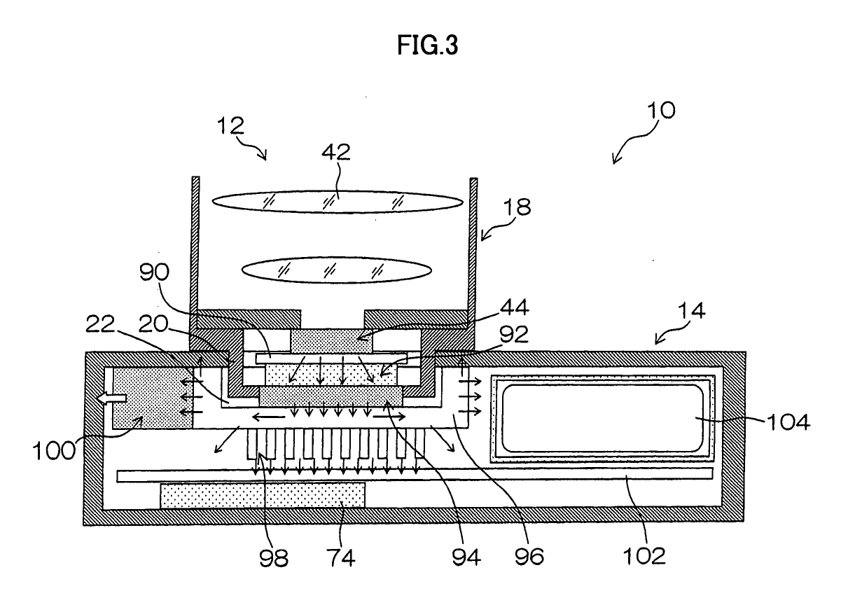

FIG. 3 is a sectional view of an essential portion of a first embodiment of the lens-interchangeable camera combining an image pickup device and the interchangeable lens unit combining an image pickup device in accordance with the present invention, arranged to solve the above-described problem. As shown in FIGS. 1 and 2, the lens-interchangeable camera 10 combining the image pickup device is constructed so that the lens unit 12 is attached to the camera body 14 through the lens unit connection portion 16. The lens unit 12 is constituted by the lens barrel portion 18 and the camera body fitting portion 20 and has, as its main internal components, the picture taking lens 42, the CCD 44, a circuit board 90 on which the CCD 44 is mounted, a heat conducting portion 92 which abuts the circuit board 90 and conducts heat, and a heat conducting elastic member 94 which elastically abuts the heat conducting portion 92 so as to be in close contact with the same, which conducts heat, and which is provided in the surface of the camera body fitting portion 20 abutting the camera body 14.

On the other hand, the recessed lens unit fitting portion 22 is provided in the surface of the camera body 14 generally in the form of a rectangular box. The lens unit fitting portion 22 is formed so as to be covered with a heat conducting portion 96 for conducting heat. In the camera body 14, a heat sink constituted by the heat conducting portion 96 and heat radiating fins 98, a cooling device 100 which abuts the heat conducting portion 96 and dissipates conducted heat, a circuit board 102 on which the digital signal processing circuit 68, etc., are mounted, the LCD 74 and a strobe control section 104 are provided as main internal components. When the lens unit 12 is mounted on the camera body 14, the heat conducting elastic member 94 provided in the camera body fitting portion 20 of the lens unit 12 elastically abuts the heat conducting portion 96 provided in the lens unit fitting portion 22 of the camera body 14 so as to be in close contact with the same.

In the thus-constructed lens-interchangeable camera 10 combining the image pickup device, the lens unit 12 is attached to the camera body 14 by fitting the camera body fitting portion 20 in the lens unit fitting portion 22 of the camera body 14 and is electrically connected through the mount contacts 56 and 60 (shown only in FIG. 2). In this state, the camera 10 operates as described below.

First, the CPU 64 provided in the camera body 14 detects the electrical connection, reads out various sorts of data necessary for adjustment of the lens unit 12 from the system memory 52 provided in the lens unit 12, loads a control program for controlling the cooling device 100, stores the program in the system memory 66 provided in the camera body 14, and executes control of the cooling device 100 as well as control of the lens unit 12. When the CCD 44 is driven, it starts generating heat. The generated heat is conducted to the heat conducting portion 96 provided on the lens unit fitting portion 22 of the camera body 14 mainly along the lens optical axis direction through the CCD mount circuit board 90, the heat conducting portion 92 and the heat conducting elastic member 94 in the lens unit 12. Further, part of the heat conducted to the heat conducting portion 96 is conducted to the heat radiating fins 98 abutting the heat conducting portion 96 at a predetermined position to be radiated, and another part of the heat is conducted to the cooling device 100 abutting the heat conducting portion 96 at another predetermined position to be dissipated. At this time, the heat radiating fins 98 and the cooling device 100 are controlled so that the temperature in the lens unit 12 is within a predetermined range.

If heat conducting silicon (heat dissipating silicon gel), a heat conducting elastomer or a metal such as copper or aluminum is used as a material for the heat conducting elastic member 94, or if a heat pipe is used as the heat conducting elastic member 94, a preferable heat conducting characteristic and close contact can be achieved. Some of such materials and member may be combined to improve the heat conduction efficiency. Preferably, the area through which the heat conducting portion 92 and the heat conducting elastic member 94 provided in the lens unit 12 abut the CCD 44 is set generally equal to or larger than the area of the CCD 44 to improve the heat conduction efficiency.

As described above, when the lens unit 12 is connected to the camera body 12 through the lens unit connection portion 16 in the lens-interchangeable camera 10 combining the image pickup device in this embodiment, the heat conducting elastic member 94 provided in the camera body fitting portion 20 of the lens unit 12 and capable of abutting the CCD 44 directly or through the heat conducting portion 92 elastically abuts the heat conducting portion 96 on the lens unit fitting portion 22 of the camera body 14 so as to be in close contact with the same, thereby allowing heat generated, for example, from the CCD 44 and the circuit board 90 in the lens unit 12 to be conducted to the camera body to be dissipated. Thus, only the operation to attach the lens unit to the camera body is performed without any additional operation to enable heat generated in the lens unit to be easily conducted to and dissipated in the camera body with efficiency so that the temperature in the lens unit is maintained in the predetermined range. Since the heat conducting elastic member 94 suitable for the CCD 44 and the circuit board 90 or the like provided in the lens unit 12 is provided in advance integrally with the lens unit 12, a user is not required to perform any additional operation even when the lens unit is changed.

In this embodiment, the heat conducting elastic member 94 abuts the image pickup device 44 through the circuit board 90 and the heat conducting portion 92. The arrangement may alternatively be such that the heat conducting elastic member 94 abuts the image pickup device 44 only through the circuit board 90 without intermediary of the heat conducting portion 92. Also, the arrangement may be such the heat conducting elastic member 94 abuts the image pickup device 44 only through the heat conducting portion 92. For example, an opening is formed in the circuit board 90, and the image pickup device is placed in the opening and mounted on the heat conducting portion.

While in this embodiment the heat conducting elastic member 94 is provided in the camera body fitting portion 20 of the lens unit 12, it may alternatively be provided in the lens unit fitting portion 22 of the camera body 14. Preferably, in such a case, the heat conducting portion 92 of the lens unit 12 is provided in the surface of the camera body fining portion 20 abutting the camera body 14, and the heat conducting elastic member 94 is provided in the heat conducting portion 96 provided on the lens unit fitting portion 22 of the camera body 14. Thus, the heat conducting elastic member 94 is provided as a member corresponding to the shape of the camera body, the heat conducting portion of the camera body or the lens unit connection portion of the camera body or a characteristic of a material to efficiently conduct heat.

The heat conducting elastic member 94 may be constructed as a member independent of the lens unit 12 and the camera body 14. In such a case, it is preferable to provide the heat conducting portion 92 of the lens unit 12 in the surface of the camera body fitting portion abutting the camera body 14. The user is thereby enabled to interchange and selectively use heat conducting elastic members according to his/her preference or need due to a wearing condition.

Further, the heat conducting elastic member 94 may be constructed in combination of a mechanism detachably attached to at least one of the lens unit 12 and the camera body 14. In such a case, the user can selectively use and interchange heat conducting elastic members according to his/her preference or need due to a wearing condition. Also, the heat conducting elastic member may be combined integrally with the lens unit or the camera body to enable the lens unit to be used by being easily attached detachably to the camera body.

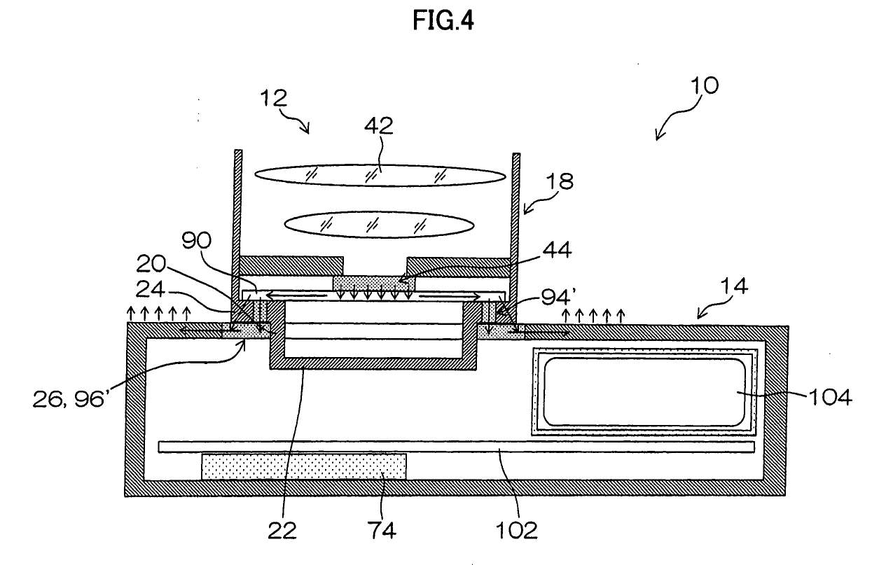

FIG. 4 is a diagram schematically showing an essential portion of a second embodiment of the lens-interchangeable camera combining an image pickup device and the interchangeable lens unit combining an image pickup device in accordance with the present invention. Components of this embodiment identical or corresponding to those of the first embodiment are indicated by the same reference numbers and the detailed description for them will not be repeated.

As shown in FIG. 4, the lens unit 12 in the lens-interchangeable camera 10 combining an image pickup device is constructed so as to be attached to the camera body 14 through a lens unit connection portion 16. When the lens unit 12 is attached to the camera body 14, the surfaces of the lens unit 12 and the camera body 14 abut each other at their mount abutment portions 24 and 26. The lens unit 12 has as its main internal components a picture taking lens 42, a CCD 44, and a circuit board 90 on which the image pickup device is mounted in a state of abutting the same. A heat conducting elastic member 94′ is provided in the mount abutment portion 24. The heat conducting elastic member 94′ has its one end maintained in abutment on the CCD mount circuit board 90 and has the other end exposed in the external surface of the lens unit 12. On the other hand, a recessed lens unit fitting portion 22 is provided in the surface of the camera body 14 generally in the form of a rectangular box. A heat conducting portion 96′ is formed in the amount abutment portion 26. A circuit board 102 on which a digital signal processing circuit 68, etc., are provided, an LCD 74 and a strobe control section 104 and other components are provided in the camera body 14.

When the lens unit 12 attached to the camera body 14, the heat conducting elastic member 94′ provided in the mount abutment portion 24 of the lens unit 12 elastically abuts the CCD mount circuit board 90 in the lens unit 12 and the heat conducting portion 96′ provided in the mount abutment portion 26 of the camera body 14 so as to be in close contact with the same.

In the thus-constructed lens-interchangeable camera 10 combining the image pickup device in this embodiment, the CCD 44 is driven to generate heat when the lens unit 12 is attached to the camera body 14 and electrically connected. The generated heat is conducted to the circuit board 90 on which the CCD is mounted mainly in directions along a plane perpendicular to the lens optical axis to be conducted to the heat conducting portion 96′ of the camera body 14 through the heat conducting elastic member 96′ provided in the mount abutment portion 24 provided on the periphery of the circuit board 90. If heat is conducted mainly in directions along a plane perpendicular to the lens optical axis, the need for provision of a heat conducting portion and a heat conducting elastic member in the camera body fitting portion 20 of the lens unit 12 is eliminated to enable the camera body fitting portion 20 to be reduced in the optical direction, thereby achieving a reduction in the thickness of the camera body 14 in the optical axis direction. If heat conducting silicon (heat dissipating silicon gel), a heat conducting elastomer or a metal such as copper or aluminum is used as a material for the heat conducting elastic member 94′, or if a heat pipe is used as the heat conducting elastic member 94′, a preferable heat conducting characteristic and close contact can be achieved. Some of such materials and member may be combined to improve the heat conduction efficiency.

While in this embodiment the heat conducting elastic member 94′ is provided in the lens unit 12, it may alternatively be provided in the mount abutment portion 26 of the camera body 14. In such a case, a heat conducting portion having its one end brought into abutment on the CCD mount circuit board 90 in the lens unit 12 and having the other end exposed in the external surface of the lens unit 12 is provided in the mount abutment portion 24 of the lens unit, and the CCD mount circuit board 90 and the heat conducting elastic member 94′ provided in the mount abutment portion 26 of the camera body 14 are brought into elastic close contact with each other through the heat conducting portion. In this way, the heat conducting elastic member 94′ is provided as a member corresponding to the shape of the mount abutment portion of the camera body or a characteristic of a material for example, thus achieving efficient heat conduction.

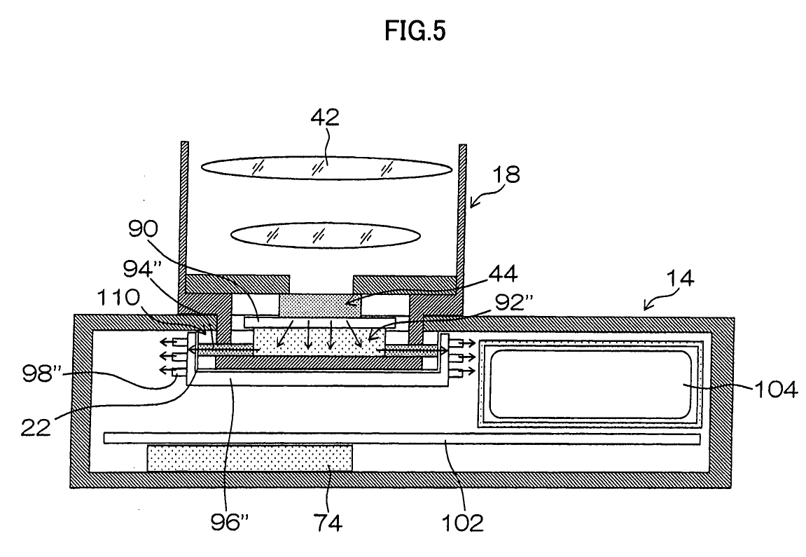

FIG. 5 is a diagram schematically showing an essential portion of a third embodiment of the lens-interchangeable camera combining an image pickup device and the interchangeable lens unit combining an image pickup device in accordance with the present invention. Components of this embodiment identical or corresponding to those of the first and second embodiments are indicated by the same reference numbers and the detailed description for them will not be repeated.

As shown in FIG. 5, the lens unit 12 in the lens-interchangeable camera 10 combining an image pickup device is constructed so as to be attached to the camera body 14 through a lens unit connection portion 16 with a lock mechanism. The lens unit 12 is constituted by a lens barrel portion 18 and a camera body fitting portion 20. Lock claws 110 are provided on the camera body fitting portion 20. The lens unit 12 has as its main internal components a picture taking lens 42, a CCD 44, a circuit board 90 on which the image pickup device is mounted in a state of abutting the same, a heat conducting portion 92″ abutting the circuit board 90, and heat conducting elastic members 94″ which abut the heat conducting portion 92″, and which are passed through the lock claws 110 to be exposed in external surfaces of the lock claws 110. On the other hand, a recessed lens unit fitting portion 22 having lock claw engagement grooves (not shown) is provided in the surface of the camera body 14 generally in the form of a rectangular box. A heat conducting portion 96″ is formed so as to cover the lens unit fitting portion 22. A heat sink constituted by the heat conducting portion 96″ and heat radiating fins 98″, a circuit board 102 on which a digital signal processing circuit 68, etc., are provided, an LCD 74 and a strobe control section 104 and other components are provided in the camera body 14.

When the lens unit 12 is fitted to the lens unit connection portion 16 of the camera body 14 and attached by being turned, the lock claws 110 of the lens unit are engaged with the lock claw engagement grooves (not shown) provided in the lens unit fitting portion of the camera body 14; the lens unit 12 and mount contacts 56 and 60 in the camera body 14 are connected to each other; and the heat conducting elastic members 94″ provided in the lock claws 110 of the lens unit 12 are in elastic close contact with the heat conducting portion 92″ in the lens unit 12 and the heat conducting portion 96″ provided in the lens unit fitting portion 22 of the camera body 14.

In the thus-constructed lens-interchangeable camera 10 combining the image pickup device in this embodiment, the CCD 44 is driven to generate heat when the lens unit 12 is attached to the camera body 14 with the lock mechanism and electrically connected. The generated heat is dissipated by being conducted to the heat conducting portion 96″ provided on the lens unit fitting portion 22 of the camera body 14 and to heat radiating fins 98″ through the circuit board 90 on which the CCD is mounted, the heat conducting portion 92″ and the heat conducting elastic members 94″ provided in the lock claws 110. Thus, the lock claws are used and the heat conducting member is provided through a wider area along a plane perpendicular to the lens optical axis, thereby reliably fixing the lens unit on the camera body and enabling heat generated in the lens unit to be conducted and released to the outside of the camera body with higher efficiency.

What is claimed is:

1. A lens-interchangeable camera combining an image pickup device, comprising:
a lens unit having a lens and the image pickup device;
a camera body having a lens unit connection portion to which the lens unit can be detachably attached; and
a heat conducting elastic member which elastically abuts the lens unit and the camera body when the lens unit is attached to the camera body through the lens unit connection portion, and which conducts heat generated by the lens unit to the camera body.

2. The camera according to claim 1, wherein the lens unit has a circuit board on which the image pickup device is mounted in a state of abutting thereon, and the heat conducting elastic member has its one surface maintained in abutment on the circuit board directly or through a heat conducting portion and has its another surface maintained in abutment on the camera body.

3. The camera according to claim 1, wherein the lens unit has a circuit board connected to the image pickup device, and the heat conducting elastic member has its one surface maintained in abutment on the image pickup device directly or through a heat conducting portion and has its another surface maintained in abutment on the camera body.

4. The camera according to claim 1, wherein the heat conducting elastic member is provided in a mount abutment portion at which the lens unit and a surface of the camera body abut each other when the lens unit is attached to the lens unit connection portion.

5. The camera according to claim 2, wherein the heat conducting elastic member is provided in a mount abutment portion at which the lens unit and a surface of the camera body abut each other when the lens unit is attached to the lens unit connection portion.

6. The camera according to claim 3, wherein the heat conducting elastic member is provided in a mount abutment portion at which the lens unit and a surface of the camera body abut each other when the lens unit is attached to the lens unit connection portion.

7. The camera according to claim 1, wherein the heat conducting elastic member is provided on the lens unit.

8. The camera according to claim 2, wherein the heat conducting elastic member is provided on the lens unit.

9. The camera according to claim 3, wherein the heat conducting elastic member is provided on the lens unit.

10. The camera according to claim 1, wherein the heat conducting elastic member is provided in the camera body.

11. The camera according to claim 2, wherein the heat conducting elastic member is provided in the camera body.

12. The camera according to claim 3, wherein the heat conducting elastic member is provided in the camera body.

13. The camera according to claim 1, wherein the heat conducting elastic member is formed so as to be detachably attached to at least one of the lens unit and the camera body.

14. The camera according to claim 2, wherein the heat conducting elastic member is formed so as to be detachably attached to at least one of the lens unit and the camera body.

15. The camera according to claim 3, wherein the heat conducting elastic member is formed so as to be detachably attached to at least one of the lens unit and the camera body.

16. The camera according to claim 1, further comprising: at least one of a heat sink and a cooling fan provided in the camera body to maintain the temperature in the camera within a predetermined range.

17. The camera according to claim 2, further comprising: at least one of a heat sink and a cooling fan provided in the camera body to maintain the temperature in the camera within a predetermined range.

18. The camera according to claim 3, further comprising: at least one of a heat sink and a cooling fan provided in the camera body to maintain the temperature in the camera within a predetermined range.

19. The camera according to claim 1, wherein the camera body has in its front surface a lens unit connection portion to which the lens unit can be detachably connected, and has a display monitor in its rear surface.

20. The camera according to claim 2, wherein the camera body has in its front surface a lens unit connection portion to which the lens unit can be detachably connected, and has a display monitor in its rear surface.

21. The camera according to claim 3, wherein the camera body has in its front surface a lens unit connection portion to which the lens unit can be detachably connected, and has a display monitor in its rear surface.

22. An interchangeable lens unit combining an image pickup device, comprising:
a lens unit including:
a lens;
the image pickup device; and
a circuit board on which the image pickup device is mounted, wherein said lens unit being detachably attached to a camera body; and
a heat conducting elastic member abutting on the circuit board of the lens unit directly or through a heat conducting portion for conducting generated heat, wherein said heat conducting elastic member can elastically abut on the camera body when the lens unit is attached to the camera body.

23. An interchangeable lens unit combining an image pickup device, comprising:
a lens unit including:
a lens;
the image pickup device; and
a circuit board on which the image pickup device is mounted, wherein said lens unit being detachably attached to a camera body; and
a heat conducting elastic member abutting the image pickup device of the lens unit directly or through a heat conducting portion for conducting generated heat, wherein said heat conducting elastic member can elastically abut the camera body when the lens unit is attached to the camera body.
